(19) United States
(12) Patent Application Publication
(10) Pub. No.: US 2026/0209555 A1
(43) Pub. Date: Jul. 23, 2026

(54) METHYLENE CHLORIDE-FREE SOLVENT CEMENT COMPOSITIONS

(71) Applicant: IPS Corporation, Compton, CA (US)

(72) Inventors: Xiaoyi Xie, Diamond Bar, CA (US); Rajesh Ranjan, Irvine, CA (US)

(21) Appl. No.: 19/426,594

(22) Filed: Dec. 19, 2025

Related U.S. Application Data
(60) Provisional application No. 63/747,982, filed on Jan. 22, 2025.

(51) Int. Cl. C09J 4/00; C08J 5/12; C09J 11/06; C09J 11/08

(52) U.S. Cl. CPC C09J 4/00; C08J 5/12; C09J 11/06; C09J 11/08; C08J 2333/02

(57) ABSTRACT

A methylene chloride-free solvent cement composition including trans-1,2-dichloroethylene and a nitro solvent are described herein. Also described herein are methods of joining two or more objects such as two or more polymer plastics, the methods including applying a composition comprising trans-1,2-dichloroethylene and a nitro solvent to at least one surface of the first object and/or second object and contacting the first object and the second object with the composition on the at least one surface between the first object and the second object.

### FIELD OF THE INVENTION

The present invention relates generally to methylene chloride (also known as dichloromethane or DCM)-free solvent cement compositions such as for bonding acrylic plastics. In addition, the present invention relates to a method of using DCM-free solvent cement compositions of the present invention, in joining and/or bonding acrylic and/or other plastic substrates.

### BACKGROUND OF THE INVENTION

There is a need for safer, more environmentally sustainable bonding solutions in industries using polymethyl methacrylate (PMMA) and other acrylic materials. Traditional solvent cements for acrylic plastics rely heavily on DCM due to its solvency, rapid evaporation rate, and effectiveness in creating strong, clear bonds. However, DCM is high volatile, toxic, and poses environmental concerns.

Methylene chloride-based solvent cements work through a mechanism known as solvent welding by which the DCM temporarily dissolves and softens the acrylic surfaces, allowing polymer chains from each component to diffuse and interlock. This results in a robust, nearly invisible bond upon evaporation of the solvent. However, DCM poses significant hazards during handling and application, including respiratory and neurological risks from inhalation and skin absorption. Exposure to DCM can cause damage to the skin, eyes, liver, and the central nervous system.

Potential DCM alternatives, such as methyl acetate, acetone, ethyl acetate, and methyl ethyl ketone (MEK), have been evaluated based on their solvency, evaporation rates, and safety profiles. However, each alternative presents unique challenges, particularly in achieving a balance between fast drying times and minimal bond strengths. For example, acetone is a powerful solvent with rapid evaporation but can lead to uneven curing and stress cracks if not modified with other components. Methyl acetate and ethyl acetate offer lower toxicity and good solubility for acrylic polymers yet may require blending with slower-evaporating solvents to improve bond uniformity and reduce stress on the plastic materials. Thus, many formulations that exhibit lower toxicity or are safer do not have sufficiently aggressive solvency characteristics, and as a result are not practical for use in acrylic cementing applications.

### SUMMARY OF EXAMPLE EMBODIMENTS

For purposes of summarizing the disclosure and describing certain advantages that may be achieved, certain objects have been described. Of course, it is to be understood that not necessarily all such objects or advantages may be achieved in accordance with any particular embodiment of the disclosure. Thus, for example, those skilled in the art will recognize that the disclosure may be embodied or carried out in a manner that achieves or optimizes one advantage or group of advantages as taught herein without necessarily achieving other objects or advantages as may be taught or suggested herein.

Aspects of the present invention relate to dichloromethane (DCM)-free solvent cement compositions such as for bonding acrylic plastics.

One aspect of the present invention relates to solvent cement compositions comprising trans-1,2-dichloroethylene and a nitro solvent.

Another aspect of the present invention relates to a method of joining polymer plastics, the method comprising: combining trans-1,2-dichloroethylene and a nitro solvent to form a solvent cement composition, optionally wherein the combining includes homogenizing the solvent cement composition until the solvent cement solution is homogenous; and bonding two or more polymer plastics together via application of the solvent cement composition to at least one surface of one of the two or more polymer plastics.

The foregoing and other aspects of the present invention will now be described in more detail including other embodiments described herein.

### DETAILED DESCRIPTION

The present invention will now be described more fully hereinafter. This invention may, however, be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. All publications, patent applications, patents and other references mentioned herein are incorporated by reference in their entirety. In case of a conflict in terminology, the present specification is controlling.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

As used herein, the transitional phrase “consisting essentially of” (and grammatical variants) is to be interpreted as encompassing the recited materials or steps “and those that do not materially affect the basic and novel characteristic(s)” of the claimed invention. See, In re Herz, 537 F.2d 549, 551-52, 190 U.S.P.Q. 461, 463 (CCPA 1976) (emphasis in the original); see also MPEP § 2111.03. Thus, the term “consisting essentially of” as used herein should not be interpreted as equivalent to “comprising.”

The term “about,” as used herein when referring to a measurable value such as an amount or concentration and the like, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measurable value may include any other range and/or individual value therein.

As used herein, the terms “increase,” “increases,” “increased,” “increasing,” and similar terms indicate an elevation in the specified parameter or value of at least about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 300%, 400%, 500% or more.

As used herein, the terms “reduce,” “reduces,” “reduced,” “reduction,” “inhibit,” and similar terms refer to a decrease in the specified parameter or value of at least about 5%, 10%, 15%, 20%, 25%, 30%, 35%, 40%, 45%, 50%, 55%, 60%, 65%, 70%, 75%, 80%, 85%, 90%, 95%, 97%, or 100%.

According to some embodiments of the present invention provided herein are solvent cement compositions that are devoid of DCM. In some embodiments, a solvent cement composition of the present invention that is devoid of DCM can maintain comparable bonding performance for acrylic plastics compared to a solvent cement composition that includes DCM. A solvent cement composition of the present invention may comprise one or more DCM-free solvent(s) (e.g., a DCM-free solvent blend) that can dissolve or soften acrylic surfaces to allow polymer interdiffusion. In some embodiments, a solvent cement composition of the present invention that is devoid of DCM can meet industry standards for bond strength, clarity, and/or durability. In some embodiments, a solvent cement composition of the present invention is devoid of a halohydrocarbon other than trans-1,2-dichloroethylene. In some embodiments, a solvent cement composition of the present invention is devoid of DCM and comprises trans-1,2-dichloroethylene as the primary solvent-providing halohydrocarbon of the solvent compositions,

Trans-1,2-dichloroethylene (t-DCE) is a chlorinated solvent. t-DCE is clearly differentiated from traditional chlorinated solvents such as methylene chloride (DCM), trichloroethylene (TCE) and tetrachloroethylene (PCE) on human health, safety, and environmental properties.

The invention encompasses formulations that can have a fast drying time, high bond strength, low toxicity, and/or is environmentally friendly. In some embodiments, a composition of the present invention is a DCM-free solvent cement composition that is suitable for high-quality, high-strength bonds in a variety of applications, from consumer goods to automotive and architectural uses. In some embodiments, a DCM-free solvent cement composition of the present invention has a strong bond strength to plastic materials such as those used for bonding acrylic plastics within a reasonable cure time.

A solvent cement composition as provided by the present invention comprises t-DCE and a nitro solvent. In some embodiments, the solvent cement composition is a mixture comprising t-DCE and the nitro solvent. In some embodiments, the solvent cement composition is for bonding polymer plastics. In some embodiments, the solvent cement composition may include polymer plastics including an acrylic polymer. In some embodiments, the solvent cement composition may include an acrylic polymer including polymethyl methacrylate (PMMA).

In some embodiments, the solvent cement composition may include an acrylic resin. An acrylic resin may comprise a polymer and/or a copolymer of a (meth)acrylate monomer that is a C₁ to C₂₀ alkyl ester of (meth)acrylic acid. In some embodiments, the solvent cement composition comprises a (meth)acrylate monomer. Exemplary (meth)acrylate monomers that may be present in a composition of the present invention and/or that may be used to provide an acrylic resin include, but are not limited to, methyl (meth)acrylate, ethyl (meth)acrylate, propyl (meth)acrylate, isopropyl (meth)acrylate, isobutyl (meth)acrylate, sec-butyl (meth)acrylate, t-butyl (meth)acrylate, tetrahydrofurfuryl (meth)acrylate, 2-ethyl hexyl (meth)acrylate, hydroxyethyl (meth)acrylate, dicyclopentadienyl (meth)acrylate, isobornyl (meth)acrylate, and mixtures and/or blends thereof.

In some embodiments, the solvent cement composition comprises an acrylic resin in an amount of about 3%, 6%, 9%, 12%, 15%, 18%, 21%, 24%, 27%, 30%, 33%, 36%, 39%, 40%, or any value or range therebetween, by weight based on of the total weight of the solvent cement composition. In some embodiments, the solvent cement composition comprises an acrylic resin ranging from about 3% to about 21%, about 4% to about 22%, about 5% to about 23%, about 6% to about 24%, about 7% to about 25%, about 8% to about 26%, about 9% to about 27%, about 10% to about 28%, about 11% to about 29%, about 12% to about 30%, about 13% to about 31%, about 14% to about 32%, about 15% to about 33%, about 16% to about 34%, about 17% to about 35%, about 18% to about 36%, about 19% to about 37%, about 20% to about 38%, about 21% to about 39%, or about 22% to about 40% by weight of the solvent cement composition. In some embodiments, the solvent cement composition comprises an acrylic resin in an amount ranging from about 3% to about 40% by weight based on of the total weight of the solvent cement composition. In some embodiments, the solvent cement composition comprises an acrylic resin in an amount ranging from about 5% to about 25% by weight based on of the total weight of the solvent cement composition. In some embodiments, the solvent cement composition comprises an acrylic resin in an amount ranging from about 8% to about 18% by weight based on of the total weight of the solvent cement composition.

In some embodiments, the solvent cement composition comprises a (meth)acrylate monomer (e.g., methyl (meth)acrylate)) in an amount of about 0.1%, 0.25%, or 0.5% to about 0.75%, 1%, 1.25%, or 1.5%, or any value or range therebetween, by weight based on of the total weight of the solvent cement composition. In some embodiments, the solvent cement composition comprises a (meth)acrylate monomer (e.g., methyl (meth)acrylate)) in an amount of about 1% by weight based on of the total weight of the solvent cement composition.

In some embodiments, the nitro solvent is and/or comprises a nitroalkane and/or a nitroaromatic. One or more (e.g., 1, 2, 3, 4, 5, 6, or more) nitro solvent(s) may be present in a solvent cement composition of the present invention. In some embodiments, the solvent cement composition comprises a nitroalkane including an aliphatic compound with high polarity due to an electron-withdrawing nitro (—NO₂) group. In some embodiments, the solvent cement composition comprises a nitroalkane that is selected from nitromethane, nitroethane, 1-nitropropane, 2-nitropropane, 1-nitrobutane, 2-nitrobutane, 1,3-dinitropropane, and mixtures and/or blends thereof. In some embodiments, the solvent cement composition comprises a nitroaromatic that is selected from nitrobenzene, nitrotoluene, dinitrotoluene, and/or trinitrotoluene, and mixtures and/or blends thereof.

In some embodiments, the solvent cement composition comprises trans-1,2-dichloroethylene in an amount of at least about 10%, 15%, 20%, 30%, 35%, 40%, 45%, 50%, 55%, 60%, 65%, 70%, 75%, 80%, 85%, 90%, 95%, 100%, or any value or range therebetween, by weight based on of the total weight of the solvent cement composition. In some embodiments, the solvent cement composition comprises trans-1,2-dichloroethylene in an amount of at least about 10% by weight based on of the total weight of the solvent cement composition. In some embodiments, the solvent cement composition comprises trans-1,2-dichloroethylene in an amount of about 10% to about 70% by weight based on of the total weight of the solvent cement composition. In some embodiments, the solvent cement composition comprises trans-1,2-dichloroethylene in an amount of about 40% to about 70% by weight based on of the total weight of the solvent cement composition. In some embodiments, the solvent cement composition comprises trans-1,2-dichloroethylene in an amount of about 30% to about 60% by weight based on of the total weight of the solvent cement composition. In some embodiments, the solvent cement composition comprises trans-1,2-dichloroethylene in an amount of about 35% to about 55% by weight based on of the total weight of the solvent cement composition.

In some embodiments, the solvent cement composition comprises a nitro solvent in an amount of 0.1%, 0.2%, 0.3%, 0.4%, 0.5%, 0.6%, 0.7%, 0.8%, 0.9%, 1%, 5%, 10%, 15%, 20%, 25%, 30%, 35%, 40%, 45%, 50%, 55%, 60%, 65%, 70%, 75%, 80%, 85%, 90%, or any value or range therebetween, by weight based on of the total weight of the solvent cement composition. In some embodiments, the solvent cement composition comprises a nitro solvent present in an amount ranging from about 0.1% to about 10%, about 0.5% to about 20%, 1% to about 30%, about 1.5% to about 40%, about 2% to about 50%, about 2.5% to about 60%, about 3% to about 70%, about 3.5% to about 80%, about 4% to about 90%, or range of values therebetween, by weight based on of the total weight of the solvent cement composition. In some embodiments, the solvent cement composition comprises a nitro solvent present in an amount ranging from about 0.1% to about 90% by weight based on of the total weight of the solvent cement composition. In some embodiments, the solvent cement composition comprises a nitro solvent present in an amount ranging from about 5% to about 80% by weight based on of the total weight of the solvent cement composition. In some embodiments, the solvent cement composition comprises a nitro solvent present in an amount ranging from about 10% to about 60% by weight based on of the total weight of the solvent cement composition.

In some embodiments, the solvent cement composition comprises an additive. Exemplary additives include, but are not limited to those selected from: an alkanol, an organic solvent, a volatile organic compound (VOC) exempt solvent, a stabilizer, an inhibitor, a surfactant, an antioxidant, fluorocarbons, fluorine-based solvents, and mixtures and blends thereof. In some embodiments, the solvent cement composition comprises an alkanol selected from the group consisting of: methanol, ethanol, isopropanol, n-butanol, isooctanol, methyl isobutyl carbinol, isoamyl alcohol, isobutyl alcohol, tert-butyl alcohol, cyclohexanol, methyl cyclohexanol, benzyl alcohol, furfuryl alcohol, 2-phenoxyethanol, and mixtures and/or blends thereof. In some embodiments, the solvent cement composition comprises an organic solvent selected from the group consisting of: acetone, methyl acetate, ethyl acetate, t-butyl acetate, methyl formate, dimethyl carbonate, diethyl carbonate, propylene carbonate, para-chlorobenzotrifluoride, dimethylformamide, and mixtures and/or blends thereof. In some embodiments, the solvent cement composition comprises a volatile organic compound (VOC) exempt solvent that does not contribute to ozone or ozone depletion.

In some embodiments, the solvent cement composition comprises an additive in an amount of up to about 0.1%, 0.5%, 1%, 5%, 10%, or any value or range therebetween, of the total weight of the solvent cement composition. In some embodiments, the solvent cement composition comprises an additive in an amount of about 0.1% to about 5% by weight based on the total weight of the solvent cement composition. In some embodiments, the solvent cement composition comprises an additive in an amount of about 1% to 10% by weight based on the total weight of the solvent cement composition. In some embodiments, the solvent cement composition comprises an alkanol, an organic solvent, a volatile organic compound (VOC) exempt solvent, a stabilizer, an inhibitor, a surfactant, and/or an antioxidant in an amount of about 0.1% to 10% by weight based on the total weight of the solvent cement composition.

In some embodiments, the solvent cement composition comprises an additive in an amount of up to about 30%, 35%, 40%, 45%, 50%, or any value or range therebetween, by weight based on of the total weight of the solvent cement composition. In some embodiments, the solvent cement composition comprises an additive in an amount of up to about 30% by weight based on of the total weight of the solvent cement composition. In some embodiments, the solvent cement composition comprises an additive in an amount of up to about 50% by weight based on of the total weight of the solvent cement composition. In some embodiments, the solvent cement composition comprises an organic solvent, a volatile organic compound (VOC) exempt solvent, a fluorocarbon and/or a fluorine-based solvent in an amount of up to about 30% to 50% by weight based on the total weight of the solvent cement composition.

In some embodiments, the solvent cement composition has a cure time of about 24 hours, 36 hours, 48 hours, 60 hours, 72 hours, 84 hours, 96 hours, 108 hours, 120 hours, 132 hours, 144 hours, 156 hours, 168 hours, or any value or range therebetween in ambient conditions. In some embodiments, ambient conditions may include a temperature of about 20° C., 21° C., 22° C., 23° C., 24° C., 25° C., 26° C., 27° C., 28° C., 29° C., 30° C., or any value or range therebetween. In some embodiments, ambient conditions may include a relative humidity of about 20%, 25%, 30%, 35%, 40%, 45%, 50%, or any value or range therebetween. In some embodiments, the solvent cement composition may include a cure time ranging from about 24 hours to about 72 hours, about 36 hours to about 84 hours, about 48 hours to about 96 hours, about 60 hours to about 108 hours, about 72 hours to about 120 hours, about 84 hours to about 132 hours, about 96 hours to about 144 hours, about 108 hours to about 156 hours, about 120 hours to about 168 hours, or any range of values therebetween, in ambient conditions. In some embodiments, the solvent cement composition may include a cure time ranging from about 24 hours to about 168 hours in ambient conditions.

In some embodiments, the solvent cement composition may include a grab time of 45 seconds, 50 seconds, 55 seconds, 60 seconds, 65 seconds, 70 seconds, 75 seconds, 80 seconds, 85 seconds, 90 seconds, 95 seconds, 100 seconds, 105 seconds, 110 seconds, 115 seconds, 120 seconds, or any value or range therebetween. In some embodiments, the solvent cement composition may include a grab time ranging about 45 seconds to about 60 seconds, about 60 seconds to about 75 seconds, about 75 seconds to about 90 seconds, about 90 seconds to about 105 seconds, about 105 seconds to about 120 seconds, or any range of values therebetween. In some embodiments, the solvent cement composition may include a grab time ranging from about 45 seconds to about 120 seconds.

In some embodiments, the solvent cement composition has a lap shear strength about 1,100 psi, 1,200 psi, 1,300 psi, 1,400 psi, 1,500 psi, 1,600 psi, 1,700 psi, 1,800 psi, 1,900 psi, 2,000 psi, 2,100 psi, 2,200 psi, 2,300 psi, 2,400 psi, 2,500 psi, 2,600 psi, 2,700 psi, 2,800 psi, 2,900 psi, 3,000 psi, 3,100 psi, 3,200 psi or any value or range therebetween, when compressed until failure with a 30 kN load cell at a rate of 0.05 inch per minute. In some embodiments, the solvent cement composition has a lap shear strength ranging from about 1,100 psi to about 2,100 psi, from about 1,200 psi to about 2,200 psi, from about 1,300 psi to about 2,300 psi, from about 1,400 psi to about 2,400 psi, from about 1,500 psi to about 2,500 psi, from about 1,600 psi to about 2,600 psi, from about 1,700 psi to about 2,700 psi, from about 1,800 psi to about 2,800 psi, from about 1,900 psi to about 2,900 psi, from about 2,000 psi to about 3,000 psi or from about 2,000 psi to about 3,200 psi when compressed until failure with a 30 kN load cell at a rate of 0.05 inch per minute. In some embodiments, the solvent cement composition has a lap shear strength ranging from about 1,100 psi to about 3,200 psi when compressed until failure with a 30 kN load cell at a rate of 0.05 inch per minute.

In some embodiments, the solvent cement composition has dispersion (δD) of about 15 MPa^{1/2}, 16 MPa^{1/2}, 17 MPa^{1/2}, 18 MPa^{1/2}, or any value or range therebetween. In some embodiments, the solvent cement composition has dispersion (δD) in an amount ranging from about 15 MPa^{1/2} to about 16 MPa^{1/2}, 16 MPa^{1/2} to about 17 MPa^{1/2}, 17 MPa^{1/2} to about 18 MPa^{1/2}, or any range of values therebetween. In some embodiments, the solvent cement composition has dispersion polarity (δP) of 8 MPa^{1/2}, 9 MPa^{1/2}, 10 MPa^{1/2}, 11 MPa^{1/2}, 12 MPa^{1/2}, 13 MPa^{1/2}, 14 MPa^{1/2}, 15 MPa^{1/2}, 16 MPa^{1/2}, 17 MPa^{1/2}, 18 MPa^{1/2}, 19 MPa^{1/2}, or any value or range therebetween. In some embodiments, the solvent cement composition has polarity (δP) in an amount ranging from about 8 MPa^{1/2} to about 12 MPa^{1/2}, from about 9 MPa^{1/2} to about 13 MPa^{1/2}, from about 10 MPa^{1/2} to about 14 MPa^{1/2}, from about 11 MPa^{1/2} to about 15 MPa^{1/2}, from about 12 MPa^{1/2} to about 16 MPa^{1/2}, from about 13 MPa^{1/2} to about 17 MPa^{1/2}, from about 14 MPa^{1/2} to about MPa^{1/2}, from about 15 MPa^{1/2} to about 19 MPa^{1/2}, or any range of values therebetween. In some embodiments, the solvent cement composition has dispersion and hydrogen bonding (δH) of about 3 MPa^{1/2}, 4 MPa^{1/2}, 5 MPa^{1/2}, 6 MPa^{1/2}, or any value or range therebetween. In some embodiments, the solvent cement composition has bonding (δH) in an amount ranging from about 3 MPa^{1/2} to about 5 MPa^{1/2}, from about 4 MPa^{1/2} to about 6 MPa^{1/2}, or any range of values therebetween. In some embodiments, dispersion (δD), polarity (δP), and hydrogen bonding (δH) of the solvent cement composition are in an amount ranging from about 15 MPa^{1/2} to about 18 MPa^{1/2}, from about 8 MPa^{1/2} to about 19 MPa^{1/2}, and from about 3 MPa^{1/2} to about 6 MPa^{1/2}, respectively.

A method of joining two or more objects (e.g., a first object and a second object and/or two or more polymer plastics) according to embodiments, of the present invention may comprise applying a solvent cement composition comprising trans-1,2-dichloroethylene and a nitro solvent to at least one surface of one of the two or more objects; and contacting the two or more objects together with the solvent cement composition on the at least one surface between the two or more objects, thereby joining the two or more objects. In some embodiments, the method comprises bonding the two or more objects together. In some embodiments, the two or more objects are acrylic plastic objects.

In some embodiments, a method of joining two or more objects (e.g., a first object and a second object and/or two or more polymer plastics) according to some embodiments of the present disclosure, may include combining trans-1,2-dichloroethylene and a nitro solvent to form a solvent cement composition, optionally including homogenizing the solvent cement composition optionally until the solvent cement solution is homogenous, and bonding two or more polymer plastics via application of the solvent cement composition to at least one surface of one of the two or more objects.

In some embodiments, the method may include bonding by bringing two or more objects (e.g., polymer plastics) into contact with one another before, during, or after the solvent cement composition is applied thereto.

In some embodiments, the method may include applying the solvent cement composition via capillary cementing, soaking, brushing, or any combination thereof.

In some embodiments, the method may include a solvent cement composition as described herein.

According to some embodiments, provided herein are solvent cement compositions that contain a DCM-free solvent blend which may dissolve acrylic resin in the composition and dissolve the surfaces of the acrylic substrate to be bonded as well. In some embodiments, the solvent blends disclosed herein may be employed in performing solvent welding, for which the solvent blends may dissolve and/or soften an acrylic surface and may allow\polymer chains from each component to diffuse and/or interlock, forming a robust, nearly invisible bond upon evaporation of the solvents. In some embodiments, a solvent blend is a mixture of trans-1,2-dichloroethylene and a nitro solvent.

A solvent cement composition and/or solvent blend of the present invention may achieve a synergistic effect by combining two or more solvents (e.g., trans-1,2-dichloroethylene and a nitro solvent). “Synergistic”, “synergy”, or grammatical variants thereof as used herein refer to a composition (e.g., a solvent cement composition and/or solvent blend) exhibiting an effect greater than the effect that would be expected from the sum of the effects of the individual components (e.g., solvents) of the composition alone. For example, the terms “synergistic” or “synergy” with regard to a solvent cement composition and/or solvent blend of the present invention refers to a property and/or feature of the solvent cement composition and/or solvent blend (e.g., solvency power such solvency power to soften or dissolve an acrylic surface, evaporation rate, bond uniformity, bond strength, etc.) that is greater than that which would be expected from the sum of the individual effects of trans-1,2-dichloroethylene and a nitro solvent alone.

In some embodiments, a solvent cement composition of the present invention has a synergistic effect and/or a high solvency power to initiate softening of the acrylic surface and improve bond strength.

Trans-1,2-dichloroethylene is a chlorinated solvent and is a colorless, volatile liquid with good solvent power for dissolving various plastics substrates. In some embodiments, trans-1,2-dichloroethylene with strong solvency power may effectively soften PMMA surfaces, allowing the polymer chains to mobilize and inter-diffuse. However, on its own, this solvent may evaporate too quickly or unevenly, leading to stress cracking or weak bonds. The present inventors discovered that pairing trans-1,2-dichloroethylene with a slower-evaporating, compatible solvent can help extend working time, allowing better surface interaction and minimizing stresses during curing. Thus, a solvent blend of the present invention may provide a more controlled bond formation, which may allow more time for the polymer chains to properly interlock among molecular chains and/or to form strong entanglements, and/or may simultaneously promote the adhesion strength before complete solvent removal.

A solvent blend and/or composition of the present invention comprises one or more (e.g., 1, 2, 3, 4, 5, or more) nitro solvent(s). It will be appreciated by one having skill in the relevant art that nitro solvents have higher polarity and relatively higher boiling points. In some embodiments, nitro solvents may include, but are not limited to, nitroalkanes and nitroaromatics. In some embodiments, nitroalkanes may include, but are not limited to, nitromethane, nitroethane, 1-nitropropane, 2-nitropropane, 1-nitrobutane, 2-nitrobutane, and 1,3-dinitropropane. In some embodiments, nitroalkanes may include aliphatic compounds with relatively high polarity due to an electron-withdrawing nitro (—NO₂) group. In some embodiments, nitroaromatics may include, but are not limited to, nitrobenzene, nitrotoluene, dinitrotoluene, and trinitrotoluene. In some embodiments, a solvent cement composition of the present invention comprises nitromethane and/or nitroethane. In some embodiments, a solvent cement composition of the present invention comprises nitromethane.

A solvent cement composition of the present invention comprising trans-1,2-dichloroethylene and a nitro solvent may have and/or provide strong solvency for dissolving an acrylic resin. In some embodiments, a synergistic blend of the present invention may provide an effective pathway toward safer and sustainable acrylic bonding solutions by leveraging the strengths of different solvents, achieving the solubility, evaporation control, and clarity required for robust, high-quality bonds.

Hansen Solubility Parameter (HSP), developed by Charles M. Hansen in 1967, is a valuable tool for predicting whether a solvent or solvent blend can dissolve a specific polymer like polymethyl methacrylate (PMMA). The HSP model considers three main intermolecular forces that determine the interaction between solvents and polymers: dispersion forces (δD), polar forces (δP), and hydrogen bonding forces (δH). Each of these forces is assigned a specific solubility parameter. The three parameters can be treated as co-ordinates for a point in three dimensions also known as the Hansen space. The nearer two molecules are in this three-dimensional space, the more likely they are to dissolve into each other.

Each polymer has a “solubility sphere” or radius of interaction, Ro, which represents the range within which a solvent or solvent blend will be able to dissolve a given polymer. For example, for PMMA, the typical radius of interaction is about 7-9 MPa^{0.5}. This value determines the radius of the sphere in Hansen space and its center is the three Hansen parameters. The solubility distance (Ra) between the polymer and a solvent (or blend) is calculated to see if it falls within a compatible range for dissolution. The Ra value is defined by the equation:

Ra=[4(δD_{polymer}−δDₛₒₗᵥₑₙₜ)²+(δP_{polymer}−δPₛₒₗᵥₑₙₜ)²+(δH_{polymer}−δHₛₒₗᵥₑₙₜ)²]^{1/2}

The solubility distance measures the compatibility between the solvent and PMMA, with lower values indicating better compatibility. If Ra≤Ro, the solvent or solvent blend is likely to dissolve PMMA. If Ra>Ro, the solvent or blend is unlikely to dissolve PMMA effectively.

In some embodiments, acrylic resins may be useful for making solvent cements for bonding acrylic plastics. For example, acrylic resins can include polymers and copolymers of (meth)acrylic ester monomers including C₁ to C₂₀ alkyl esters of (meth)acrylic acid. Exemplary (meth)acrylate monomers can include, but are not limited to, methyl (meth)acrylate, ethyl (meth)acrylate, propyl (meth)acrylate, isopropyl (meth)acrylate, isobutyl (meth)acrylate, sec-butyl (meth)acrylate, t-butyl (meth)acrylate, tetrahydrofurfuryl (meth)acrylate, 2-ethyl hexyl (meth)acrylate, hydroxyethyl (meth)acrylate, dicyclopentadienyl (meth)acrylate, isobornyl (meth)acrylate, and mixtures and/or blends thereof.

Examples of acrylic polymers and/or copolymers which may be included in a composition of the present invention include, but are not limited to, those available from a variety of commercial sources such as acrylic polymers commercially available from LG CHEM®, South Korea under the designation as IH830™, IG840™, IF850™, IF860™ and IF870™; acrylic polymers commercially available from PLASKOLITE® Inc. under the designation as OPTIX® CA-30, OPTIX® CA-41™, OPTIX® CA-51™, OPTIX® CA-61™ OPTIX® CA-81™ and OPTIX® CA-86™; and acrylic polymers available from LUCITE® International Inc. under the trade designation as ELVACITE® 2010, ELVACITE®2016™ ELVACITE®2041™, ELVACITE®2043™, ELVACITER2044™, and ELVACITER2046™.

The concentration of acrylic resin in the solvent cement compositions disclosed herein affects their viscosities. The concentration chosen for particular embodiments should be selected in keeping with the desired viscosity of the intended product. In some embodiments of the present invention, an amount of acrylic resin is used ranging from about 3% to about 40%, about 5% to about 25%, or about 8% to about 18% by weight of the total cement composition.

In some embodiments, methyl methacrylate (MMA) monomer is included in a solvent cement composition of the present invention and may improve bond strength of the solvent cement composition. MMA monomers can partially dissolve the surfaces of the acrylic parts being joined, which may allow for better fusion. This softening effect can cause the solvent cement to “weld” the two surfaces together by creating a strong, cohesive bond as the MMA monomer evaporates and the plastic re-hardens. In some embodiments, the addition of MMA may enhance solubility as MMA may aid in making the acrylic resin more soluble in the other solvents within the formulation, leading to a smoother, more consistent application and better penetration into the joint. In some embodiments, MMA monomer may enhance the adhesive, physical, and working properties of a solvent cement composition of the present invention, resulting in stronger, more reliable, and/or less brittle bonds. The total amount of MMA may be in an amount of up to about 10% based on the total cement composition or up to about 5% based on the total cement the composition.

In some embodiments, a small amount of an additive such as alkanols may be included in solvent cement composition of the present invention. In some embodiments, such alkanols may include, but are not limited to, methanol, ethanol, isopropanol, n-butanol, isooctanol, methyl isobutyl carbinol, isoamyl alcohol, isobutyl alcohol, tert-butyl alcohol, cyclohexanol, methyl cyclohexanol, benzyl alcohol, furfuryl alcohol, 2-phenoxyethanol and the like. In some embodiments, alkanols with higher boiling points may be included in a solvent cement composition of the present invention. For example, butanol may provide a supportive role to slow down the evaporation of some solvent cement compositions. By way of further example, butanol (boiling point 117° C.) has a slower evaporation rate compared to other low boiling solvents commonly used in acrylic cements, such as acetone, methyl acetate or MEK (methyl ethyl ketone). By slowing down the drying time, butanol may provide more time for the other solvents to penetrate and/or soften an acrylic surface, ensuring a stronger bond. The slower evaporation rate and moderate viscosity of butanol may help a solvent cement composition to spread more evenly across a joint area. Butanol may also minimize bubble formation in a solvent cement composition of the present invention by slowing the release of volatile solvents, leading to a clearer, more aesthetically pleasing joint. The total amount of such additives may be in an amount of up to about 10% based on the total weight of the solvent cement composition or up to about 5% based on the total weight of the solvent cement the composition.

In some embodiments, a solvent cement composition of the present invention may include other organic solvents such as acetone, methyl acetate, ethyl acetate, t-butyl acetate, methyl formate, dimethyl carbonate, diethyl carbonate, propylene carbonate, para-chlorobenzotrifluoride, dimethylformamide and other substances that can be used as solvents with different evaporation rates to achieve an evaporation control. For example, volatile organic compound (VOC)-exempt solvents which do not contribute to ozone or ozone depletion, may be included to lower VOC levels and thus to comply with strict VOC regulations. In some embodiments, a solvent cement composition of the present invention may include small amounts of one or more fluorocarbon(s) and/or fluorine-based solvent(s) to reduce the flammability of the solvent cement composition. Further, a solvent cement composition of the present invention for bonding acrylic plastics may include any other kinds of substance provided they do not impair the effect of the present invention.

In some embodiments, a solvent cement composition of the present invention may contain other components that do not materially affect the composition's exceptional solvency power. For example, a solvent cement composition of the present invention can also contain one or more additives, such as stabilizers, inhibitors, surfactants, and antioxidants. Examples of such additives include, but are not limited to, phenols, amines, ethers, esters, organic phosphates, epoxides, furans, alcohols, ketones, and/or triazoles. Such additives typically are added at the expense of the other components and in amounts known to one skilled in the art. The total amount of such additives may be in an amount of up to about 10% based on the weight of the solvent cement composition or up to about 5% based on the weight of the solvent cement composition.

The present invention is explained in greater detail in the following non-limiting Examples.

### EXAMPLES

Several specific solvent cement compositions of the present invention were made as described hereinafter. Unless otherwise indicated, all parts and percentages are by weight.

### Ingredients

The following ingredients were used in the examples provided hereinafter:

| | Boiling | | |
|---|---|---|---|
| | Point | Density | |
| Ingredient Name | (° C.) | (g/ml) | Supplier |
| Dichloromethane (DCM) | 40 | 1.325 | SIGMA-ALDRICH ® |
| Trans-1,2-Dichloroethylene | 48 | 1.257 | A.G. LAYNE ® |
| (t-DCE) | | | |
| Nitromethane | 101 | 1.137 | SIGMA-ALDRICH ® |
| 1-Nitropropane | 132 | 0.998 | SIGMA-ALDRICH ® |
| 2-Nitropropane | 120 | 0.982 | SIGMA-ALDRICH ® |
| Nitrobenzene | 211 | 1.199 | SIGMA-ALDRICH ® |
| Methyl methacrylate (MMA) | 101 | 0.940 | LUCITE ® |
| PMMA (ELVACITE ® 2041) | N/A | 1.190 | LUCITE ® |

### Mixing

The solvent cement compositions may be prepared by admixing the selected solvents in suitable containers such as metal cans or glass bottles. There is no particular order of solvent addition during mixing. One or more components or additives may be optionally added at once. In the case of adding solid contents such as acrylic resins, the solids may be added into the liquid mix. After tightly sealing with a cap or lid, the container was placed on an agitation equipment such as a lab shaker, magnetic stirrer, or roller mill depending on the batch size for an enough time to fully dissolve the polymer in the solvent mixture and form a homogeneous solution.

### Application Method

There are several methods for bonding acrylic plastics with solvent cements depending on the type of joints and shapes characteristics of the substrates. The common methods are capillary cementing, soaking, and brushing.

Capillary cementing is the most popular method of joining acrylic components. A low viscosity solvent cement is allowed to flow along the surfaces to be joined via capillary action. The parts to be bonded are either unclamped or very lightly clamped together. The cement is dispensed from a needle-nozzled applicator bottle, transfer pipet, syringe, or similar means along the edge of the joint. Capillary action draws the cement through the consistent narrow gap between the parts. Do not disturb the joint and let it dry completely before removing the clamps.

Higher viscosity cements or thicken cements can be used to cement joints that can't be easily cemented by capillary or solvent soak methods. Viscous cement can fill small gaps to make strong and transparent joints. Apply the viscous cement with a brush, spatula, or directly from a suitable applicator.

### Hansen Solubility Parameters of Solvent Blends

For solvent blends, the HSP values are calculated as the weighted average of each component based on its volume fraction in the blend. The combined HSP values (δD_{blend}, δP_{blend}, δH_{blend}) are calculated as:

$$\begin{matrix}δ {D}_{blend} = \sum fi \cdot δ Di \\ δ {P}_{blend} = \sum fi \cdot δ Pi \\ δ {H}_{blend} = \sum fi \cdot δ Hi\end{matrix}$$

where fi is the volume fractions of each solvent in the blend, and δDi, δPi and δHi are the HSP values for each solvent.

### Grab Time

Grab time in the context of acrylic solvent cement refers to the initial period during which the cement begins to set and develop enough tackiness to hold the bonded substrates together. It is the time after application when the solvent starts to evaporate, causing the acrylic surfaces to soften and bond. A grab time varies depending on the solvent used, Different solvent evaporates at a different rate which is affected by environmental conditions like temperature and humidity.

Lap joints were made with 2 pieces of 1×1×¼ inch acrylic panels. Immediately after applying cement with an applicator, the joint panels were clamped with 2 medium binder clips (1¼ inch). Prepared several sets of joints. Each joint was tested by twisting the panels with hands to feel the strength of bonded area at different time periods. Record the time as grab time at which the joint was no longer twisted and separated by hand.

### Lap Shear Bond Strength

Each sample of the solvent cement compositions was evaluated to measure the lap shear strength on acrylic substrates according to ASTM D2564. A clear PLEXIGLAS® cast acrylic sheet (¼ inch thick, 6.4 mm) was cut into test coupons with dimension of 1×1 inch (25.4×25.4 mm) and 2×1 inch (50.8×25.4 mm). A fresh surface of the substrates was exposed by removing the protection film right before use. Stack a 1×1 inch piece onto the center section of a 2×1 inch piece to form an overlap cement joint with 1 inch overlap. The solvent cement compositions were applied using a disposable transfer pipet or a needle tip applicator onto test substrates at the edge of the joint. The cement joint was fixed with 2 medium binder clips (1¼ inch) and stored at room temperature (i.e., about 23° C., humidity 30-50%) for 24 hours, 72 hours and 7 days, respectively. Four test specimens were made with each cement formulation at each storage time. The cement joint was tested until failure by compression loading on a universal material testing machine (INSTRON®, Model 3367) equipped with a 30 kN (6,750 lbf) load cell at a rate of 0.05 inch (1.27 mm) per minute. The lap shear strengths are an average of four measurements and are reported in psi (pound per square inch) to the nearest whole number. The debonded cement joints were visually inspected to determine the failure mode.

### Examples 1-12

The compositions of the various solvent cements for bonding acrylics including using a single solvent and solvent blends were listed in Table 1. The Hansen solubility parameters of these solvents cements and the solubility distance (Ra) between the PMMA polymer and a solvent (or blend) were calculated and listed in Table 2. The grab time and lap shear strength obtained with these solvent cements were summarized in Table 3.

TABLE 1

| | Solvent Cement Compositions | | | | | | | |
|---|---|---|---|---|---|---|---|---|
| | | | Nitro- | 1-Nitro- | 2-Nitro- | Nitro- | | |
| Example | DCM | t-DCE | methane | propane | propane | benzene | MMA | PMMA |
| 1 | 100 | | | | | | | |
| 2 | | 100 | | | | | | |
| 3 | | | 100 | | | | | |
| 4 | | 94 | 5 | | | | 1 | |
| 5 | | 88 | 11 | | | | 1 | |
| 6 | | 68 | 31 | | | | 1 | |
| 7 | | 50 | 49 | | | | 1 | |
| 8 | | 11 | 88 | | | | 1 | |
| 9 | | 68 | | 31 | | | 1 | |
| 10 | | 68 | | | 31 | | 1 | |
| 11 | | 68 | | | | 31 | 1 | |
| 12 | | 50 | 36 | | | | 1 | 13 |

TABLE 2

| | Hansen | | | | |
|---|---|---|---|---|---|
| | Solubility | | | HSP | |
| | Parameters | | | Distance | |
| | (MPa)^{0.5} | | | (MPa)^{0.5} | RED |
| Example | δD | δP | δH | Ra | Ra/Ro. |
| PMMA | 18.6 | 10.5 | 5.1 | Ro = 8.0 | |
| 1 | 18.2 | 6.3 | 6.1 | 4.4 | 0.55 |
| 2 | 16.7 | 7.8 | 3.3 | 5.0 | 0.63 |
| 3 | 15.8 | 18.8 | 5.1 | 10.1 | 1.26 |
| 4 | 16.6 | 8.4 | 3.4 | 4.8 | 0.60 |
| 5 | 16.6 | 9.1 | 3.5 | 4.6 | 0.58 |
| 6 | 16.4 | 11.4 | 3.9 | 4.7 | 0.59 |
| 7 | 16.2 | 13.4 | 4.3 | 5.7 | 0.71 |
| 8 | 15.9 | 17.6 | 4.9 | 9.0 | 1.13 |
| 9 | 16.7 | 9.4 | 4.1 | 4.2 | 0.53 |
| 10 | 16.5 | 9.4 | 3.6 | 4.6 | 0.58 |
| 11 | 17.7 | 8.7 | 3.3 | 3.1 | 0.39 |
| 12 | 16.3 | 12.6 | 4.1 | 5.2 | 0.65 |

TABLE 3

| | Grab | | | |
|---|---|---|---|---|
| | Time | Lap Shear Strengths (psi) | | |
| Example | (sec) | 24 hrs | 72 hrs | 1 wk. |
| 1 | 40 | 2332 | 3007 | 2963 |
| 2 | 70 | 1544 | 1458 | 1735 |
| 3 | 60 | 1106 | 1437 | 1742 |
| 4 | 45 | 2146 | 2343 | 1991 |
| 5 | 45 | 2413 | 2562 | 3203 |
| 6 | 45 | 2825 | 3010 | 2924 |
| 7 | 45 | 2748 | 2194 | 1965 |
| 8 | 45 | 1304 | 1686 | 1753 |
| 9 | 60 | 1733 | 1628 | 1977 |
| 10 | 60 | 1485 | 1681 | 1545 |
| 11 | 60 | 1629 | 1747 | 2021 |
| 12 | 120 | 2626 | 2957 | 3091 |

In Examples 1-3, three pure solvents were directly used as a solvent cement without any additive. Test results showed that DCM is superior with a grab time of 40 seconds and strong lap shear strengths of 2332 psi at 24 hours and above 2900 psi at 72 hours and 1 week. The performance of DCM is much better than that of t-DCE and nitromethane alone regarding the lap shear strength which is below 1800 psi at the same time intervals.

In Examples 4-8, however, when a solvent blend of t-DCE and nitromethane is used, the lap shear strengths produced by these solvent blend compositions (except for Example 8 at 24 hours) were higher than the lap shear strength produced by each of t-DCE and nitromethane alone, showing the synergistic effect of two solvents together. When concentration of t-DCE increases from 11% to 94% with a decrease of nitromethane from 88% to 5%, the lap shear strength increases with an increase of t-DCE reaching to a plateau at about 70%-80% and then decreases with a further increase of t-DCE. Example 6, demonstrated particularly desirable lap shear strengths of 2825 psi at 24 hours, 3010 psi at 72 hours and 2924 psi at 1 week, while the grab time is shortened from 60-70 seconds to 45 seconds.

In Examples 9-11, when t-DCE is blended with other nitro aliphatic and nitroaromatic compounds as solvents. The lap shear strengths produced by these solvent blend compositions were also improved when compared with the lap shear strength produced by the pure solvent.

In Example 12, a higher viscosity solvent cement composition was made by adding an acrylic polymer (13%) to a solvent blend to produce a syrupy consistency cement providing some gap-filling capability. The thickened solvent cement works the same way but allows for longer solvent action due to slower evaporation. The solvent composition of Example 12 produces exceptional lap shear strengths of 2626 psi at 24 hours, 2957 psi at 72 hours and 3091 psi at 1 week, while the grab time is maintained at 2 minutes.

In addition, the calculated values of HSP solubility distance (Ra) listed in Table 2 further show in correlation with the lap shear bond strengths. The Ra value measures the compatibility between the solvent and PMMA, with lower values indicating better compatibility. If Ra≤Ro, the solvent or solvent blend is likely to dissolve PMMA. If Ra>Ro, the solvent or blend is unlikely to dissolve PMMA effectively. The Ra values in Example 3 and Example 8 are 10.1 and 9 MPa^{0.5} respectively, which are greater than the radius of interaction of PMMA which is about 7-9 MPa^{0.5}, indicating that these solvent blends may not dissolve PMMA effectively and produce poor lap shear strengths compared to other solvent blends of t-DCE and nitromethane.

### Comparative Examples 13-14

Two popular commercially available methylene chloride-based solvent cements on the market: WELD-ON® 3 and WELD-ON® 16, each of which includes DCM, for bonding acrylic plastic substrates were evaluated for comparison.

### Example 13

WELD-ON® 3 is a water-thin acrylic cement formulated for quickly cementing acrylic plastic to itself. The bond is achieved by first softening the surfaces to be joined and then fusing them together with dissipation of the solvent. The initial bond forms within a few minutes and quickly increases in strength. Substantial strength will be obtained within only a few hours. WELD-ON® 3 is used extensively in sign fabrication. Strong butt joints are made with fat sheets by using the soak method for such applications as cementing letters to acrylic panels.

### Example 14

WELD-ON® 16 is a medium-bodied, clear solvent-type acrylic cement with very high strength, especially formulated to bond acrylic plastic to itself. The fast curing time allows the bonded parts to be handled within a few minutes when applied to cast, molded or extruded acrylics. Bond strength continues to develop very rapidly, reaching a substantial level and forming strong joints within hours. WELD-ON® 16 is recommended as an excellent general purpose, high strength acrylic cement. It is especially useful where fast cure and high strength are desired for applications such as large housings, signs, plastic letters, industrial fabrications, display items, lenses and models.

The grab time and lap shear strength were tested were tested under similar conditions as Examples 1-12. Results were summarized in Table 4.

TABLE 4

| | Grab | Lap Shear Strengths (psi) | | |
|---|---|---|---|---|
| Example | Time | 24 hrs | 72 hrs | 1 wk. |
| 13 | 45 sec | 2293 | 2530 | 2724 |
| 14 | 5 min | 1955 | 2180 | 2407 |

The lap shear strengths of the inventive examples 5 and 6 are comparable or higher when compared with those of the commercial product in Example 13. In the high viscosity cement composition, the lap shear strengths of the inventive example 12 are significantly higher when compared with those of the commercial product in Example 14.

From the above examples, it can be seen that the solvent cement compositions in accordance with this disclosure provide superior bond strengths on acrylic plastic substrates, even though these solvent cements do not contain DCM, indicating that the inventive solvent cement compositions can replace DCM in such products with a solvent blend having comparable abilities, while having a lower toxicity and less extreme EPA classification which is a primary benefit of the inventive compositions over the prior art.

The foregoing is illustrative of the present invention and is not to be construed as limiting thereof. The methods, compositions, and/or devices described herein may comprise any feature described herein either alone or in combination with any other feature(s) described herein. Indeed, various modifications, in addition to those shown and described herein, will become apparent to those skilled in the art from the foregoing description and accompanying drawings using no more than routine experimentation. Such modifications and equivalents are intended to fall within the scope of the appended claims. The invention is defined by the following claims, with equivalents of the claims to be included therein.

What is claimed is:

1. A solvent cement composition comprising trans-1,2-dichloroethylene and a nitro solvent, wherein the solvent cement composition is devoid of methylene chloride.

2. The solvent cement composition of claim 1, wherein the trans-1,2-dichloroethylene is present in the composition in an amount of about 10% to about 95% by weight of the solvent cement composition.

3. The solvent cement composition of claim 1, wherein the nitro solvent is present in the composition in an amount of about 1% to about 90% by weight of the solvent cement composition.

4. The solvent cement composition of claim 1, wherein the nitro solvent comprises a nitroalkane and/or a nitroaromatic.

5. The solvent cement composition of claim 1, wherein the nitro solvent comprises a nitroalkane that comprises an aliphatic compound with high polarity due to an electron-withdrawing nitro (—NO₂) group.

6. The solvent cement composition of claim 1, wherein the nitro solvent comprises nitromethane, nitroethane, 1-nitropropane, 2-nitropropane, 1-nitrobutane, 2-nitrobutane, 1,3-dinitropropane, nitrobenzene, nitrotoluene, dinitrotoluene, trinitrotoluene, and/or any combination thereof.

7. The solvent cement composition of claim 1, further comprising an acrylic resin.

8. The solvent cement composition of claim 7, wherein the acrylic resin comprises a polymer and/or copolymer of a (meth)acrylate monomer selected from the group consisting of: methyl (meth)acrylate, ethyl (meth)acrylate, propyl (meth)acrylate, isopropyl (meth)acrylate, isobutyl (meth)acrylate, sec-butyl (meth)acrylate, t-butyl (meth)acrylate, tetrahydrofurfuryl (meth)acrylate, 2-ethyl hexyl (meth)acrylate, hydroxyethyl (meth)acrylate, dicyclopentadienyl (meth)acrylate, isobornyl (meth)acrylate, and any combination thereof.

9. The solvent cement composition of claim 7, wherein the acrylic resin is present in an amount of about 3% to about 40% by weight of the solvent cement composition.

10. The solvent cement composition of claim 1, further comprising a methyl methacrylate (MMA) monomer.

11. The solvent cement composition of claim 10, wherein the MMA monomer is present in the solvent cement composition in an amount of about 0.1% to about 10% by weight of the solvent cement composition.

12. The solvent cement composition of claim 1, further comprising an additive, wherein the additive is selected from the group consisting of: an alkanol, an organic solvent, a volatile organic compound (VOC) exempt solvent, a stabilizer, an inhibitor, a surfactant, an antioxidant, a fluorocarbon, a fluorine-based solvent, and any combination thereof.

13. The solvent cement composition of claim 12, wherein the solvent cement composition comprises the alkanol and the alkanol is selected from the group consisting of: methanol, ethanol, isopropanol, n-butanol, isooctanol, methyl isobutyl carbinol, isoamyl alcohol, isobutyl alcohol, tert-butyl alcohol, cyclohexanol, methyl cyclohexanol, benzyl alcohol, furfuryl alcohol, 2-phenoxyethanol, and any combination thereof.

14. The solvent cement composition of claim 12, wherein the solvent cement composition comprises the organic solvent and the organic solvent is selected from the group consisting of: acetone, methyl acetate, ethyl acetate, t-butyl acetate, methyl formate, dimethyl carbonate, diethyl carbonate, propylene carbonate, para-chlorobenzotrifluoride, dimethylformamide, and any combination thereof.

15. The solvent cement composition of claim 12, wherein the solvent cement composition comprises a volatile organic compound (VOC) exempt solvent that does not contribute to ozone or ozone depletion.

16. The solvent cement composition of claim 1, wherein the cure time of the solvent cement composition is for a time period ranging from about 24 hours to about 168 hours in ambient conditions.

17. The solvent cement composition of claim 1, wherein the grab time of the solvent cement composition is for a time period of about 45 seconds to about 120 seconds.

18. The solvent cement composition of claim 1, wherein the lap shear strength of the solvent cement composition is an amount ranging from about 1,100 psi to about 3,200 psi when compressed until failure with a 30 kN load cell at a rate of 0.05 inch per minute.

19. The solvent cement composition of claim 1, wherein dispersion (δD), polarity (δP), and hydrogen bonding (δH) of the solvent cement composition are in an amount ranging from about 15 MPa^{1/2} to about 18 MPa^{1/2}, from about 8 MPa^{1/2} to about 19 MPa^{1/2}, and from about 3 MPa^{1/2} to about 6 MPa^{1/2}, respectively.

20. A method of joining a first object and a second object, comprising:
applying a composition comprising trans-1,2-dichloroethylene and a nitro solvent to at least one surface of the first object and/or the second object; and
contacting the first object and the second object together with the composition on the at least one surface between the first object and the second object, thereby joining the first object and the second object.
